(19) United States
(12) Patent Application Publication
(10) Pub. No.: US 2010/0324988 A1
(43) Pub. Date: Dec. 23, 2010

(54) SYSTEMS AND METHODS FOR AGGREGATING AND REPORTING MULTI-PLATFORM ADVERTISING PERFORMANCE DATA

(75) Inventors: Joseph J. Schaar, Boonton, NJ (US); Shruti L. Pitale, Herndon, VA (US)

Correspondence Address: VERIZON;PATENT MANAGEMENT GROUP, 1320 North Court House Road, 9th Floor, ARLINGTON, VA, 22201-2909, US

(73) Assignees: VERIZON NEW JERSEY INC., Newark, NJ (US); VERIZON PATENT AND LICENSING INC., Basking Ridge, NJ (US)

(21) Appl. No.: 12/488,869

(22) Filed: Jun. 22, 2009

(51) Int. Cl. G06Q 30/00; H04N 7/025

(52) U.S. Cl. 705/14.42; 705/14.41; 725/32

(57) ABSTRACT

In an exemplary method, a computing system acquires advertising performance data from a plurality of independent advertising platform subsystems, aggregates the advertising performance data based on linking data to form a grouping of related advertising performance data, and transmits data representative of the grouping of related advertising performance data to an access device for presentation in a single graphical user interface view. In certain embodiments, the grouping of related advertising performance data comprises a subset of the advertising performance data aggregated across the plurality of independent advertising platform subsystems. In certain embodiments, the independent advertising platform subsystems are heterogeneous. In certain embodiments, the independent advertising platform subsystems distribute advertisement assets via a media outlet such as a subscriber television media outlet.

### BACKGROUND INFORMATION

As media content distribution and processing technologies have advanced, media outlets through which media content is distributed have increased both in number and type. The increased numbers and types of media outlets have provided a variety of platforms that may be used by advertisers to distribute targeted advertising content to potential consumers. However, in certain ways, the availability of a variety of advertising platforms has complicated advertising. For example, advertisers may choose from many options and platforms when deciding how to allocate advertising budgets, effectively target potential consumers, and/or maximize return on investment. To help with such choices, advertisers generally want to receive and analyze data descriptive of advertising performance. Advertisers may use this data to determine how to allocate advertising budgets and/or to determine which advertising platforms to use to disseminate certain advertising content. Unfortunately, such data has conventionally been collected and reported in a platform-specific and/or platform-independent manner, which generally requires advertisers to use a separate performance report for each advertising platform.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers designate identical or similar elements.

FIG. 1 illustrates an exemplary computing system configured to aggregate and report advertising performance data of independent advertising platforms.

FIG. 2 illustrates exemplary components of an advertising platform subsystem.

FIG. 3 illustrates an exemplary subscriber television media outlet.

FIG. 4 illustrates exemplary components of an advertising performance data aggregation and reporting subsystem.

FIG. 5 illustrates an exemplary aggregation of related advertising performance data across multiple independent advertising platforms.

FIG. 6 illustrates an exemplar graphical user interface having multi-platform advertising performance data displayed therein.

FIG. 7 illustrates an exemplary method of aggregating and reporting advertising performance data of independent advertising platforms.

### DETAILED DESCRIPTION OF PREFERRED EMBODIMENTS

Exemplary systems and methods for aggregating and reporting multi-platform advertising performance data are disclosed. The exemplary systems and methods disclosed herein may acquire and aggregate advertising performance data from multiple, independent advertising platforms, and output reporting data representative of aggregated performance data for access by one or more users (e.g., an external party such as an advertiser). For example, advertising performance data may be aggregated across a plurality of independent advertising platforms based on linking data to form at least one grouping of related advertising performance data. Reporting data representative of the grouping(s) of related advertising performance data may be transmitted to one or more access devices for presentation to one or more users.

In certain embodiments, reporting data representative of one or more groupings of related advertising performance data may be displayed in a graphical user interface (“GUI”) for viewing by a user. The GUI may include related aggregate advertising performance data for multiple, independent advertising platforms displayed in a single GUI view. Such a presentation of related aggregate advertising performance data may provide an advertiser with convenient and intuitive access to performance data for an advertising campaign that spans multiple independent advertising platforms. The aggregate performance data may provide the advertiser with information helpful for making future choices regarding allocation of advertising budgets and/or selection of advertising platforms.

Components and functions of exemplary systems and methods for aggregating and reporting multi-platform advertising performance data will now be described with reference to the drawings.

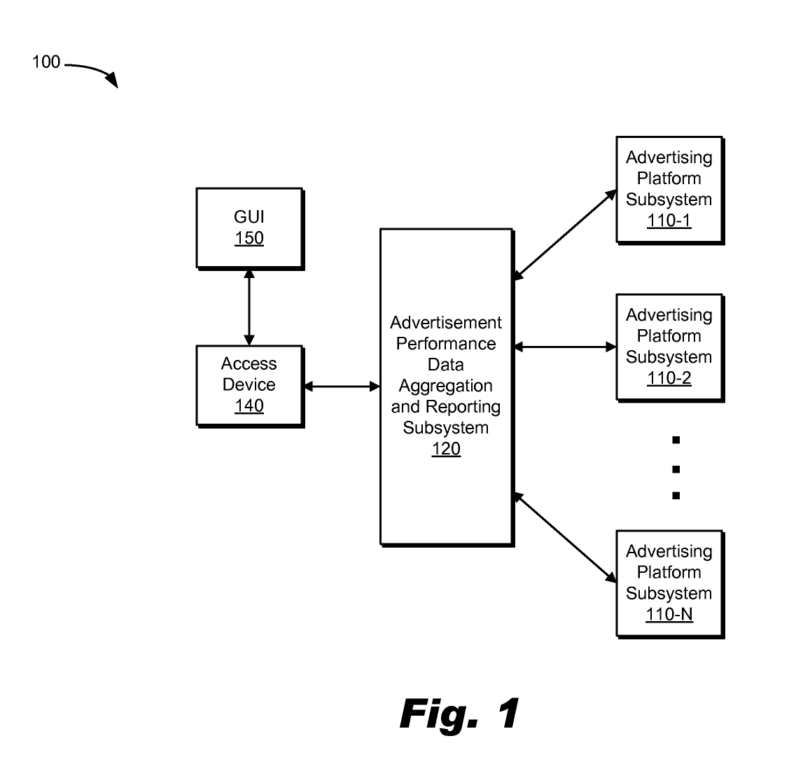

FIG. 1 illustrates an exemplary computing system 100 (or simply “system 100”) configured to aggregate and report multi-platform advertising performance data. As shown in FIG. 1, system 100 may include a plurality of independent advertising platform subsystems 110 (e.g., independent advertising platform subsystems 110-1 through 110-N) communicatively coupled to an advertisement performance data aggregation and reporting subsystem 120 (or simply “aggregation subsystem 120”), which may selectively communicate with an access device 140 that is configured to present a graphical user interface (“GUI”) 150 to a user of the access device 140.

Components of system 100 may communicate with one another using any suitable communication technologies, devices, media, and protocols supportive of data communications, including, but not limited to, the Internet, intranets, local area networks, other data communications networks, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

In certain implementations, one or more components of system 100 may be implemented in one or more computing devices. System 100 may include any computer hardware and/or instructions (e.g., software programs), or combinations of software and hardware, configured to perform one or more of the processes described herein. In particular, it should be understood that components of system 100 may be implemented on one or more physical computing devices. Accordingly, system 100 may include any one of a number of computing devices (e.g., one or more server devices), and may employ any of a number of computer operating systems. System 100 may also employ any of a number of database management tools.

Accordingly, one or more of the processes described herein may be implemented at least in part as instructions executable by one or more computing devices. In general, a processor (e.g., a microprocessor) receives instructions, e.g., from a computer-readable medium (a memory, etc.), and executes those instructions, thereby performing one or more processes, including one or more of the processes described herein. Such instructions may be stored and transmitted using a variety of known computer-readable media.

A computer-readable medium (also referred to as a processor-readable medium) may include any medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (“DRAM”), which typically constitutes a main memory. Common forms of computer-readable media may include, for example, a floppy disk, a flexible disk, hard disk, magnetic tape, any other magnetic medium, a CD-ROM, DVD, any other optical medium, a RAM, a PROM, an EPROM, a FLASH-EEPROM, any other memory chip or cartridge, or any other medium from which a computer can read.

While an exemplary system 100 is shown in FIG. 1, the exemplary components illustrated in FIG. 1 are not intended to be limiting. Other alternative hardware environments and implementations may be used in other implementations. Exemplary components of system 100 will now be described in additional detail.

Each of the advertising platform subsystems 110 may be configured to provide one or more advertising services, which may include, without limitation, maintaining data representative of one or more advertisements (also referred to as “ads” or “advertisement assets”), distributing advertisements, and generating advertisement performance data related to distribution of advertisements.

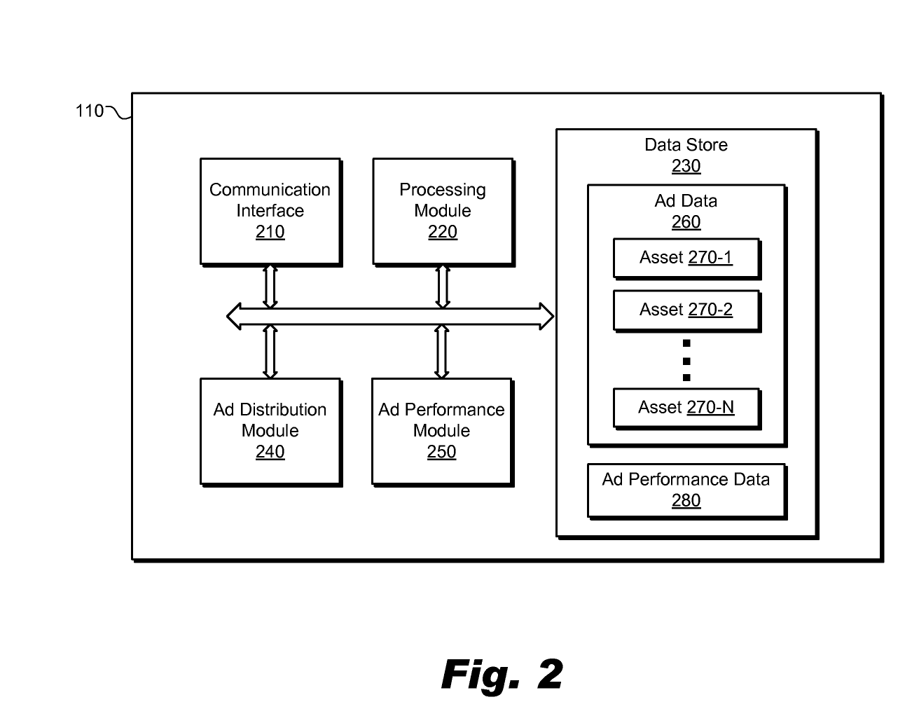

FIG. 2 illustrates exemplary components of an advertising platform subsystem 110. As shown in FIG. 2, advertising platform subsystem 110 may include a communication interface 210, processing module 220, data store 230, ad distribution module 240, and ad performance module 250 communicatively coupled to one another as illustrated in FIG. 2. The components of advertising platform subsystem 110 may communicate with one another, including sending data to and receiving data from one another, using any suitable communication technologies.

The components of advertising platform subsystem 110 may be implemented on any computing device or combination of computing devices, such as a media content processing device, a server device (e.g., an application server, video server, web server, etc.), video hub office equipment, a set-top box, a communications device, a mobile device (e.g., a mobile phone device), a handheld device, a personal computer, a phone device (e.g., Verizon Hub device), a personal-digital assistant device, a gaming device, a digital video recording (“DVR”) device (e.g., a personal video recording (“PVR”) device), a television device, and/or any media content access and/or distribution device configured to perform one or more of the advertising platform processes and/or operations described herein.

Communication interface 210 may be configured to communicate with one or more media content processing devices associated with one or more media outlets through which advertising content may be distributed. In particular, communication interface 210 may be configured to transmit data representative of advertisements to one or more media content processing devices associated with one or more media outlets. Hence, advertising platform subsystem 110 may be configured to distribute advertising content via one or more media outlets.

In addition, communication interface 210 may be configured to communicate with aggregation subsystem 120. In particular, communication interface 210 may be configured to receive requests for and transmit advertising performance data from/to aggregation subsystem 120, as described further below.

Examples of communication interface 210 may include, without limitation, a wired network interface (such as a network interface card), a wireless network interface (such as a wireless network interface card), a modem, an optical network terminal, a broadband connection interface, and any other suitable interface. In at least one embodiment, communication interface 210 may provide a direct connection between aggregation subsystem 120 and advertising platform subsystem 110 via a direct link to a network, such as the Internet. Communication interface 210 may additionally or alternatively provide such a connection through, for example, a local area network (such as an Ethernet network), a personal area network, a telephone or cable network, a cellular telephone connection, a satellite data connection, or any other suitable connection.

Processing module 220 may include one or more processors and may be configured to execute and/or direct execution of one or more advertising platform processes or operations described herein. Processing module 220 may direct execution of operations in accordance with computer-executable instructions such as may be stored in data store 230 or another computer-readable medium. As an example, processing module 220 may be configured to process data, including demodulating, decoding, and parsing acquired data, and encoding and modulating data for transmission by communication interface 110.

Data store 230 may include one or more data storage media, devices, or configurations and may employ any type, form, and combination of storage media. For example, data store 230 may include, but is not limited to, a hard drive, network drive, flash drive, magnetic disc, optical disc, RAM, DRAM, other non-volatile and/or volatile storage unit, a storage area network, or a combination or sub-combination thereof. Electronic data, including data described herein, may be temporarily and/or permanently stored in data store 230. In certain embodiments, the electronic data may be organized in one or more databases maintained in data store 230.

Ad distribution module 240 may be configured to maintain ad data 260 representative of one or more advertisements in data store 230. Ad data 260 may include any data representative of, descriptive of, or otherwise associated with one or more advertisements. In FIG. 2, ad data 260 includes data representative of a plurality of advertisement assets 270 (e.g., assets 270-1 through 270-N). Each advertisement asset 270 may represent an advertisement in one form or another. Exemplary advertisements and types of advertisements are described further below.

Ad distribution module 240 may be further configured to distribute advertisements, or provide data representative of advertisements for distribution, via one or more media outlets. For example, ad distribution module 240 may direct advertising platform subsystem 110 to transmit data representative of an advertisement asset 270 to one or more media content processing devices for access by or for further distribution to a user. Ad distribution module 240 may distribute advertisements in accordance with any predefined ad distribution heuristic(s), which may be defined as may suit a particular implementation. For example, an ad distribution heuristic may be defined to cause advertisements to be distributed to potential consumers in a targeted manner based on one or more predetermined factors.

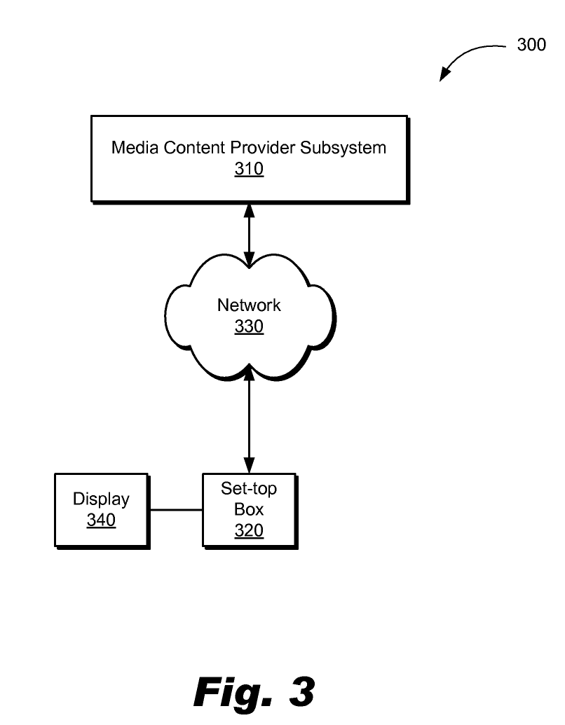

Ad distribution module 240 may be configured to distribute advertisements via a variety of media outlets. In certain embodiments, for example, ad distribution module 240 may be configured to distribute advertisements over a subscriber television media outlet such as a Verizon FiOS television system. FIG. 3 illustrates an exemplary subscriber television media outlet 300 (or simply “outlet 300”). As shown in FIG. 3, outlet 300 may include a media content provider subsystem 310 and set-top box 320 configured to communicate over a network 330. Media content provider subsystem 310 and set-top box 320 may utilize any suitable communication technologies to communicate with one another over network 330, which may include any network, or combination of networks, capable of transporting communications and media content (e.g., advertising content) between media content provider subsystem 310 and set-top box 320.

Media content provider subsystem 310 may include one or more media content distribution devices configured to transmit (e.g., broadcast, multicast, or narrowcast) data and/or signals representative of media content to set-top box 320, which may be configured to receive and process the data and/or signals. Set-top box 320 may provide data and/or signals to a display 340 (e.g., a television or computer monitor) and/or other output device such that media content may be experienced by a user associated with the set-top box 320.

In certain embodiments, media content transmitted from media content provider subsystem 310 to set-top box 320 may include one or more advertisements provided by ad distribution module 240 of one or more of advertising platform subsystems 110 for distribution via outlet 300. Additionally or alternatively, one or more advertising platform subsystems 100 may provide one or more advertisements directly to set-top box 320. Hence, one or more advertising platform subsystems 110 may provide data representative of the advertisements to media content provider subsystem 310 and/or set-top box 320 for distribution to a user associated with set-top box 320. To this end, an advertising platform subsystem 110 may include or be implemented on one or more components of outlet 300. For example, one or more components of an advertising platform subsystem 110 may be included as part of media content provider subsystem 310 and/or set-top box 320.

While FIG. 3 shows an exemplary media outlet through which advertisements and other media content may be distributed, the exemplary media outlet is illustrative only. Media content, including advertisements provided by one or more advertising platform subsystems 110, may be distributed over one or more other media outlets (e.g., a mobile phone network system, the Internet, etc.) in other implementations.

Returning to FIG. 2, ad performance module 250 may be configured to generate ad performance data representative of one or more measures of performance (i.e., performance metrics) related to distribution of advertisements by advertising platform subsystem 110. This data may be stored as ad performance data 280 in data store 230. Ad performance data 280 may include any data representative of one or more measures of performance related to distribution of advertisement assets 270 by advertising platform subsystem 110. Examples of ad performance data 280 may include, but are not limited to, impression counts indicating numbers of times that advertising assets 270 have been distributed, requested, played back, recorded, interacted with, and/or otherwise experienced by one or more users, impression counts by designated marketing areas, duration metrics indicating durations of time that advertisement assets 270 have been played back, recorded, and/or displayed, a number of total subscribers across platforms, a number of subscribers by category, a number of video-on-demand-enabled subscribers, a number of digital-video-recording-enabled subscribers, set-top box counts, counts for advertisements distributed per recipient (e.g., per set-top box), a number of distributed advertisement frames, one or more identifiers of distributed advertisement frames, advertisement viewing duration metrics, total advertisements viewed by time duration and/or mode (e.g., fast forward, standard play, rewind, etc.), timestamp information (e.g., timestamps for duration and behavior of advertising assets 270, data representative of video link-in/link-out behavior, ad selection counts (e.g., number and/or time of “clicks”), click-stream behavior data (e.g., source and counts of prior clicks), data identifying video environments from which clicks originated, breakout data indicating after-the-click behavior, and/or any other data descriptive of ad distribution performance. Some examples of ad performance data 280 will be described in more detail below.

Ad performance module 260 may be configured to generate performance data 280 in any suitable way. For example, ad performance module 260 may collect ad performance data 280 from one or more media content processing devices of a media outlet (e.g., media content provider subsystem 310 and/or set-top box 320 of outlet 300) and store the ad performance data 280 in data store 230. For instance, set-top box 320 may maintain a log of events, which may include data representative of advertisement distribution events such as display, play back, and/or insertion of advertisements for display within one or more applications (e.g., an interactive media guide application, a gaming application, etc.) executing on set-top box 320. As another example, ad performance module 260 may generate advertisement performance data 280 based on advertisement distribution information collected from one or more media content processing devices of a media outlet.

Returning to FIG. 1, the advertising platform subsystems 110 shown in FIG. 1 may be independent of one another as mentioned above. In certain embodiments, for example, the advertising platform subsystems 110 may operate independently of one another. In particular, each of the advertising platform subsystems 110 may perform one or more of the above-described advertising platform processes and/or operations independently of the advertising platform processes and/or operations performed by the other advertising platform subsystems 110. For instance, each of the advertising platform subsystems 110 may distribute advertisements and/or generate performance data independently of the other advertising platform subsystems 110. In certain embodiments, the independence of the advertising platform subsystems 110 may also include physical and/or logical separation of the advertising platform subsystems 110.

In certain embodiments, the advertising platform subsystems 110 shown in FIG. 1 may be heterogeneous. The advertising platform subsystems 110 may be heterogeneous in one or more ways. Several examples of how advertising platform subsystems 110 may be heterogeneous will now be described.

As one example, the advertising platform subsystems 110 may be configured to distribute heterogeneous types of advertisements. To this end, each of the advertising platform subsystems 110 may distribute a distinct type of advertisement via at least one media outlet. Examples of ad types that may be distributed by advertising platform subsystems 110 may include, without limitation, linear advertisements, on-demand advertisements (e.g., video-on-demand (“VOD”) advertisements), interactive advertisements, banner advertisements, application insertion advertisements, and content portal advertisements. Linear advertisements may include traditional commercials (e.g., thirty-second spots) within a media content broadcast and/or multicast channel (e.g., a commercial within a television broadcast or multicast channel). On-demand advertisements may include advertisements housed within an on-demand system (e.g., one or more on-demand content servers), such as VOD ads housed within one or more VOD servers. Interactive advertisements may include any advertisements with which a user may interact. Banner advertisements may include any advertisements that may be spatially placed within a display view provided to a user. Banner advertisements may include static and/or clickable banner ads. Application insertion advertisements may include an advertisements that may be inserted within an application such as a video game application provided by a media outlet. The advertisement types described above are illustrative only. Other advertisement types and/or combinations of advertisement types may be used in other embodiments.

In certain embodiments, advertising platform subsystems 110-1 may be configured to distribute heterogeneous types of advertisements via a common media outlet such as subscriber television media outlet 300 of FIG. 3. The heterogeneous types of advertisements may include linear video advertisements that may be distributed within television broadcast and/or multicast channels, VOD ads, interactive ads, banner ads, and application insertion ads. In certain embodiments, the VOD ads may include long-format VOD ads to which a user may be directed from a linear advertisement indicating that additional information may be accessed at a particular location in a VOD system, from a telescoping liner advertisement that provides an automated link from the linear advertisement to a VOD ad, and/or from an application running on set-top box 320 (e.g., an interactive media guide and/or menu application). In certain embodiments, the VOD ads may include placement ads configured to be presented immediately preceding, within, or after presentation of free on-demand content to a user.

In certain embodiments, the heterogeneous types of advertisements may also include interactive ads, banner ads, and/or application insertion ads. As an example, outlet 300 may provide access to video game applications. Interactive ads, banner ads, and/or application insertion ads may be placed within a video game application. For instance, a video ad may be placed within a games lobby view and/or between levels of a game. As another example, a banner ad may be placed within a specific location of a game view.

As a specific example of heterogeneous advertising platform subsystems 110, advertising platform subsystem 110-1 may be configured to distribute targeted linear advertisements, advertising platform subsystem 110-2 may be configured to distribute VOD advertisements, and advertising platform subsystem 110-N may be configured to distribute banner advertisements. Accordingly, advertising platform subsystems 110-1, 110-2, and 110-N may be heterogeneous at least because they are configured to distribute heterogeneous types of advertisements to one or more media outlets (e.g., subscriber television outlet 300).

In addition or alternative to distributing heterogeneous types of advertisements, advertising platform subsystems 110 may be heterogeneous in that they may be configured to generate heterogeneous types of advertising performance data. For example, advertising platform subsystem 110-1 may be configured to generate performance data tailored to linear advertisements (e.g., data representative of a total duration of playback and/or recording of a linear advertisement), advertising platform subsystem 110-2 may be configured to generate performance data tailored to VOD advertisements (e.g., data representative of a number of requests for a VOD advertisement), and advertising platform subsystem 110-N may be configured to generate performance data tailored to banner advertisements (e.g., data representative of a number of clicks associated with a banner ad).

In additional or alternative to heterogeneous types of advertisements and/or performance data, advertising platform subsystems 110 may be heterogeneous in that they may be configured to utilize distinct tools (e.g., distinct hardware devices and/or software applications) to generate advertising performance data 280. For example, certain advertising platform subsystems 110 may utilize heterogeneous vendor devices to generate advertising performance data 280. As another example, at least some advertising performance data 280 may be collected from different media content processing devices of a media outlet. For instance, certain advertising performance data may be collected from media content provider subsystem 310 of outlet 300 (e.g., from transmission logs) while other advertising performance data may be collected from set-top box 320 of outlet 300 (e.g., from display logs and/or user input logs of set-top box 320).

Advertising platform subsystems 110 may also be heterogeneous in that they may be configured to distribute advertisements via heterogeneous media outlets. For example, although in certain embodiments advertising platform subsystems 110 distribute advertisements via a common media outlet such as outlet 300, in other embodiments, advertising platform subsystems 110 may distribute advertisements via multiple different media outlets. For instance, advertising platform subsystem 110-1 may distribute media content, including advertisements, via a first media outlet such as subscriber television outlet 300 and advertising platform subsystem 110-2 may distribute media content, including advertisements, via a second media outlet such as a mobile phone media network outlet.

The aforementioned examples of advertising platforms are illustrative only and not limiting in any sense. In other embodiments, other combinations of independent and/or heterogeneous advertising platforms may be employed to distribute advertisements via one or more media outlets. Such combinations may include any combinations and/or sub-combinations of the exemplary advertising platform subsystems 110 described herein.

In any of the ways described above, advertising platform subsystems 110 may be heterogeneous. While heterogeneous advertising platform subsystems 110 may provide a variety of options for distributing advertising content, one or more of the above-described heterogeneous characteristics of advertising platform subsystems 110 may also provide significant obstacles and/or inconveniences to advertisers wishing to analyze and use advertising performance data to analyze distribution of advertisements and to guide future advertising choices and strategies.

Aggregation subsystem 120 may be configured to acquire and aggregate multi-platform advertising performance data across independent advertising platform subsystems 110, even when the advertising platform subsystems 110 are heterogeneous as described above. Aggregation subsystem 120 may be further configured to report aggregate advertising performance data such as by transmitting reporting data representative of aggregate performance data to access device 140 for display in GUI 150. The acquisition, aggregation, and reporting of advertising performance data associated with advertising platform subsystems 110 may provide a user of access device (e.g., an advertiser) with convenient access to aggregate, useful reporting data representative of the performance data.

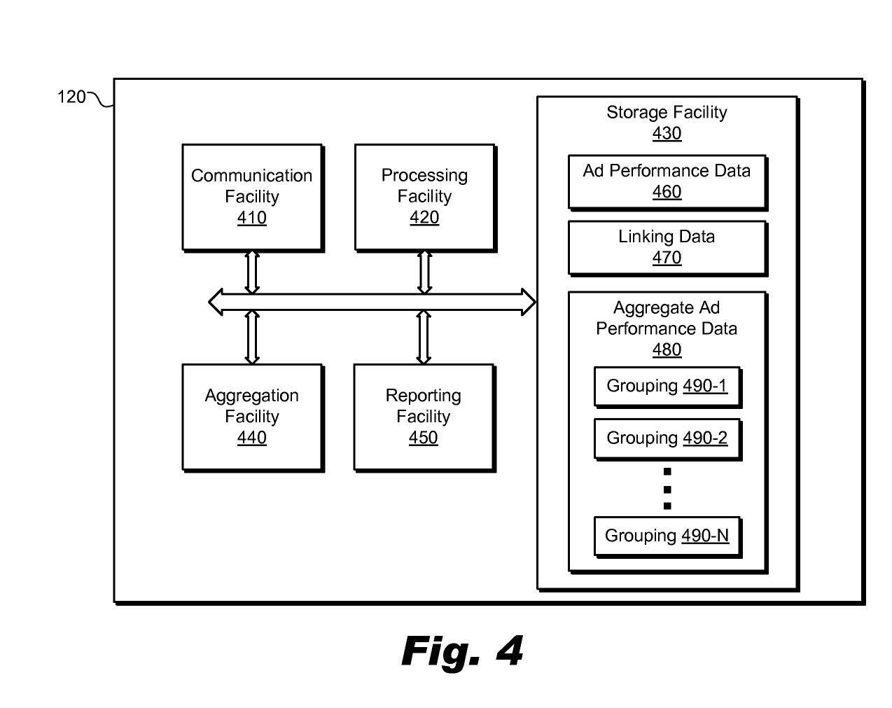

FIG. 4 illustrates exemplary components of aggregation subsystem 120. As shown in FIG. 4, aggregation subsystem 120 may include a communication facility 410, processing facility 420, storage facility 430, aggregation facility 440, and reporting facility 450 communicatively coupled to one another as illustrated in FIG. 4. The components of aggregation subsystem 120 may communicate with one another, including sending data to and receiving data from one another, using any suitable communication technologies.

The components of aggregation subsystem 120 may be implemented on any computing device or combination of computing devices, such as one or more server devices and/or server clusters (e.g., application servers, video servers, web servers, etc.) and/or one or more data storage devices (e.g., disk arrays, database devices, etc.) configured to perform one or more of the data aggregation and reporting processes and/or operations described herein.

Communication interface 410 may be configured to communicate with access device 140. For example, communication interface 410 may receive user input such as requests for advertising performance data reports. Communication interface 410 may be configured to transmit reporting data representative of performance data to access device 140, which may display such data in GUI 150.

Communication facility 410 may be further configured to communicate with one or more advertising platform subsystems 110. In particular, communication facility 410 may be configured to transmit requests for and receive advertising performance data to/from one or more advertising platform subsystems 110 to acquire advertising performance data, as described further below.

Examples of communication facility 410 may include, without limitation, a wired network interface (such as a network interface card), a wireless network interface (such as a wireless network interface card), a modem, an optical network terminal, a broadband connection interface, and any other suitable interface. In at least one embodiment, communication facility 410 may provide one or more direct connections between aggregation subsystem 120 and one or more advertising platform subsystem 110 via a direct link to a network, such as the Internet. Communication facility 410 may additionally or alternatively provide such a connection through, for example, a local area network (such as an Ethernet network), a personal area network, a telephone or cable network, a cellular telephone connection, a satellite data connection, or any other suitable connection.

Processing facility 420 may include one or more processors and may be configured to execute and/or direct execution of one or more of the processes or operations described herein. Processing facility 420 may direct execution of operations in accordance with computer-executable instructions such as may be stored in storage facility 430 or another computer-readable medium. As an example, processing facility 420 may be configured to process data, including demodulating, decoding, and parsing acquired data, and encoding and modulating data for transmission by communication facility 410.

Storage facility 430 may include one or more data storage media, devices, or configurations and may employ any type, form, and combination of storage media. For example, storage facility 430 may include, but is not limited to, a hard drive, network drive, flash drive, magnetic disc, optical disc, RAM, DRAM, other non-volatile and/or volatile storage unit, a storage area network, or a combination or sub-combination thereof. Electronic data, including data described herein, may be temporarily and/or permanently stored in storage facility 430. In certain embodiments, the electronic data may be organized in one or more databases maintained in storage facility 430.

Aggregation facility 440 may be configured to acquire ad performance data 280 from advertising platform subsystems 110. Aggregation facility 440 may acquire the ad performance data 280 from advertising platform subsystems 110 in any suitable way. In certain embodiments, for example, aggregation facility 440 may periodically (e.g., daily) and automatically request ad performance data 280 and/or updates to ad performance data 280 from advertising platform subsystems 110. Additionally or alternatively, aggregation facility 440 may request ad performance data 280 and/or updates to ad performance data 280 from advertising platform subsystems 110 in response to a predetermined event such as receipt of user input requesting performance data. In other embodiments, advertising platform subsystems 110 may automatically push ad performance data 280 to aggregation facility periodically and/or in response to predefined events such as updates to the ad performance data 280.

Aggregation facility 440 may store ad performance data 280 acquired from advertising platform subsystems 110 as ad performance data 460 in storage facility 430. Ad performance data 460 may include any of the advertisement performance metrics included in ad performance data 280 of advertising platform subsystems 110. Ad performance data 460 may also include additional information descriptive of the performance metrics and/or the sources of the performance metrics. For example, ad performance data 460 may include source identifiers indicating the particular advertising platform subsystems 110 from which data was acquired. As another example, ad performance data 460 may include asset identifiers indicating advertising assets associated with the ad performance data 460. As yet another example, ad performance data 460 may include media device identifiers indicating devices such as set-top box 320 to which advertisements were distributed.

Aggregation facility 440 may be further configured to aggregate ad performance data 460 acquired from advertising platform subsystems 110. In certain embodiments, aggregation facility 440 may aggregate ad performance data 460 from across multiple platforms based on linking data 470, which may be stored in storage facility 430. Linking data 470 may be maintained by aggregation facility 440 and may include any data indicative of one or more relationships between advertisement assets 270 associated with advertising platform subsystems 110. Examples of linking data 470 may include, without limitation, advertising asset identifiers identifying advertising assets 270, media device identifiers indicating media devices such as set-top box 320 to which advertisements have been or may be delivered, platform identifiers identifying advertising platform subsystems 110 associated with advertisement assets 270, advertising campaign identifiers indicating particular advertising campaigns, advertising content provider identifiers indicating providers of advertising assets 270, hierarchy identifiers indicating relationships between advertisement assets 270, devices, platforms, ad campaigns, advertising content providers, and any other data indicating relationships with and/or between advertisement assets 270.

As an example, linking data 470 may include a campaign identifier indicating a particular advertising campaign ordered by an advertiser. The linking data 470 may further include hierarchy identifiers indicating relationships between the advertising campaign and one or more advertising assets 270 associated with the campaign. For instance, an advertiser may provide several advertising assets 270 that are to be part of an advertising campaign. Data useful for identifying the campaign, the advertising assets 270, and the relationships of the advertising assets 270 to the campaign may be stored in linking data 470 by aggregation facility 440. In certain examples, the advertiser may provide the linking data 470 for the campaign along with the advertising assets 270. The linking data 470 may be used by aggregation facility 440 to identify the advertising assets 270 as related to the campaign and to aggregate performance data 460 associated with the identified advertising assets 270 to form a grouping of performance data 460 for the campaign.

Ad performance data that has been aggregated by aggregation facility 440 may be stored in storage facility 430 as aggregate ad performance data 480, which may include one or more groupings 490 (e.g., groupings 490-1 through 490-N) of ad performance data, as shown in FIG. 4. Each grouping 490 of ad performance data may represent an aggregation of related ad performance data based on linking data 470. For example, grouping 490-1 of ad performance data 480 may represent an aggregation of ad performance data for advertisement assets 270 associated with a particular advertiser and/or advertising campaign, or that are related to one another in any other way by linking data 470. In certain examples, a grouping 490 of ad performance data 480 may be a subset of ad performance data 460 acquired from advertising platform subsystems 110. Hence, aggregation facility 440 may selectively aggregate related portions of ad performance data 460 based on linking data 470.

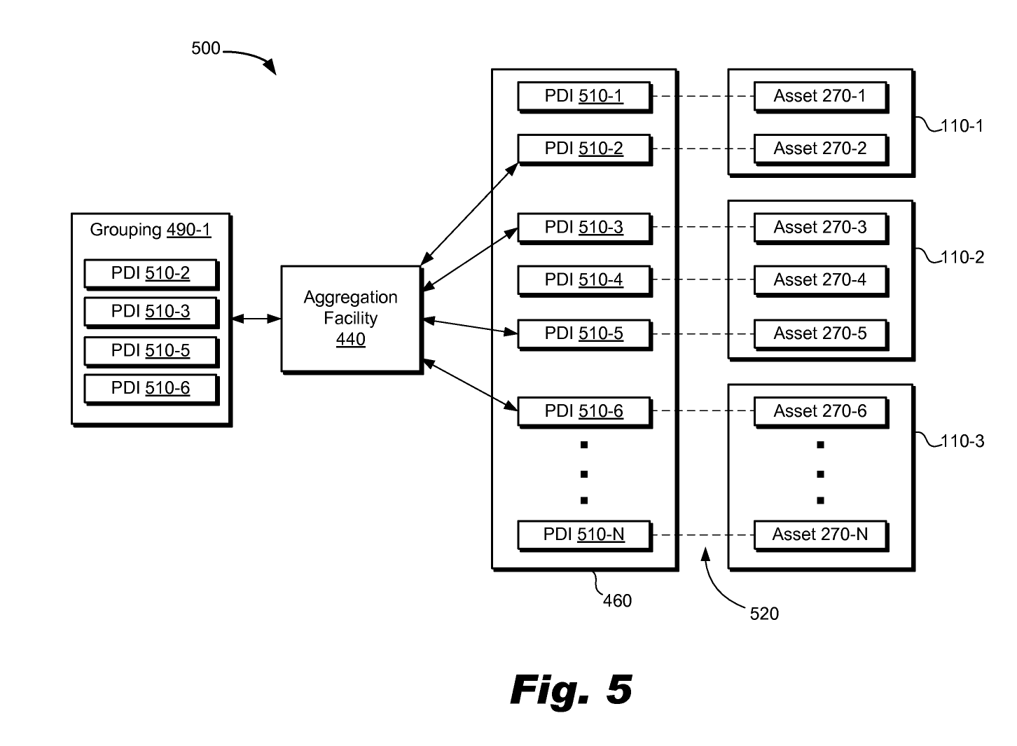

To help facilitate an understanding of aggregation of ad performance data 460 associated with related advertisement assets 270 based on linking data 470 to form a grouping 490 of aggregate ad performance data 480, FIG. 5 illustrates an exemplary aggregation 500 of select advertising performance data across multiple independent advertising platforms. As shown in FIG. 5, a plurality of advertising assets 270 (e.g., assets 270-1 through 270-N) may be respectively associated with a plurality of independent advertising platform subsystems 110 (e.g., advertising platform subsystems 110-1 through 110-3). In the illustrated example, assets 270-1 and 270-2 are associated with advertising platform subsystem 110-1, assets 270-3, 270-4, and 270-5 are associated with advertising platform subsystem 110-2, and assets 270-6 through 270-N are associated with advertising platform subsystem 110-3.

As also shown in FIG. 5, ad performance data 460 may include a plurality of performance data instances (“PDIs”) 510-1 through 510-N (collectively referred to as “PDIs 510”) associated with assets 270-1 through 270-N, respectively. Dashed lines 520 indicate the respective associations between the PDIs 510 and the assets 270 in FIG. 5. Each of the PDIs 510 may include a data structure or other instance of ad performance data associated with the corresponding asset 270.

As illustrated in FIG. 5, aggregation facility 440 may identify and aggregate select PDIs 510 to form a grouping 490-1 of the select PDIs 510. In the illustrated example, aggregation facility 440 identifies and aggregates PDIs 510-2, 510-3, 510-5, and 510-6 to form grouping 490-1 including the same PDIs 510-2, 510-3, 510-5, and 510-6. Aggregation facility 440 may identify and aggregate PDIs 510-2, 510-3, 510-5, and 510-6 based on linking data 470 indicating a relationship between assets 270-2, 270-3, 270-5, and 270-6 associated with PDIs 510-2, 510-3, 510-5, and 510-6, respectively. As an example, linking data 470 may include data representative of an advertising campaign and relationships of assets 270-2, 270-3, 270-5, and 270-6 to the advertising campaign. For instance, linking data 470 may include a campaign identifier and a list of advertising asset identifiers indicating assets 270-2, 270-3, 270-5, and 270-6 associated with the campaign identifier. Based on this information, aggregation facility 440 may search ad performance data 460 to identify PDIs 510-2, 510-3, 510-5, and 510-6 that are associated with the assets 270-2, 270-3, 270-5, and 270-6 related to the campaign identifier. Aggregation facility 440 may aggregate the identified PDIs 510-2, 510-3, 510-5, and 510-6 to form grouping 490-1. Data representative of grouping 490-1 may be stored in storage facility 430 as shown in FIG. 4.

The above-described example of aggregating ad performance data 460 associated with assets 270 of an advertising campaign is illustrative only. Select ad performance data 460 may be identified and aggregated to form one or more other groupings 490 of aggregate ad performance data 480 based on one or more other relationships represented by linking data 470.

As illustrated in FIG. 5, aggregation facility 440 may acquire and aggregate select ad performance data 460 across independent advertising platform subsystems 110. Accordingly, groupings 490 of aggregate performance data may include performance data associated with advertising assets 270 associated with multiple, independent advertising platforms.

Aggregation subsystem 120 may be further configured to provide reporting data representative of aggregate ad performance data. For example, returning to FIG. 4, reporting facility 450 may be configured to direct aggregation subsystem 120 to transmit data representative of aggregate performance data such as grouping 490-1 to access device 140 for presentation in GUI 150. Reporting data may be transmitted from aggregation subsystem 120 to access device 140 in any suitable way.

Access device 140 may comprise any computing device configured to receive reporting data from aggregation subsystem 120, generate and display GUI 150, and cause data representative of the reporting data to be displayed in GUI 150 for consideration of a user of access device 140. Examples of access device may include, without limitation, a personal computer, a communications device, a mobile device (e.g., a mobile phone device), a phone device (e.g., Verizon Hub device), and a personal-digital assistant device.

Access device 140 may be associated with an internal or external party. As used herein, “internal party” may refer to any person or organization (e.g., a service provider) distributing media content including advertisement assets 270 via a media outlet, and “external party” may refer to any person or organization that is external to (i.e., not part of) the internal party. An external party may include a customer of the internal party, including an advertiser providing advertisement assets 270 for distribution by the internal party. Accordingly, aggregation subsystem 120 may be configured to provide reporting data for consideration by an internal party and/or an external party. In particular, reporting data representative of ad performance data may be provided to an advertiser associated with access device 140 for convenient access and analysis.

In certain embodiments, an external party such as an advertiser may be able to use access device 140 to provide data representative of advertising assets 270 to an internal party for distribution, order advertising services provided by the internal party, provide linking data 470 defining relationships between assets 270 (e.g., for reporting purposes), and/or otherwise manage advertising options, assets, and reports.

Reporting facility 450 may direct aggregation subsystem 120 to communicate with access device 140 in any suitable way. In certain embodiments, for example, reporting facility 450 may provide an access portal through which a user of access device 140 may access and manage advertising options, assets, and reports. For instance, the access portal may comprise a web portal that may be used by an advertiser to access and manage advertising options, assets, and reports.

Access device 140 may be configured to generate and display GUI 150, and include reporting data representative of aggregate ad performance data 480 in GUI 150. In certain embodiments, aggregate ad performance data 480, such as aggregate ad performance data included in grouping 490-1, may be displayed in a single graphical user interface view within GUI 150. Accordingly, an advertiser and/or other user of access device 140 may access and view a dashboard display of related ad performance data that has been aggregated across multiple independent advertising platform subsystems 110. For example, an ad campaign dashboard view including a grouping 490-1 of performance data associated with an ad campaign may be displayed in GUI 150.

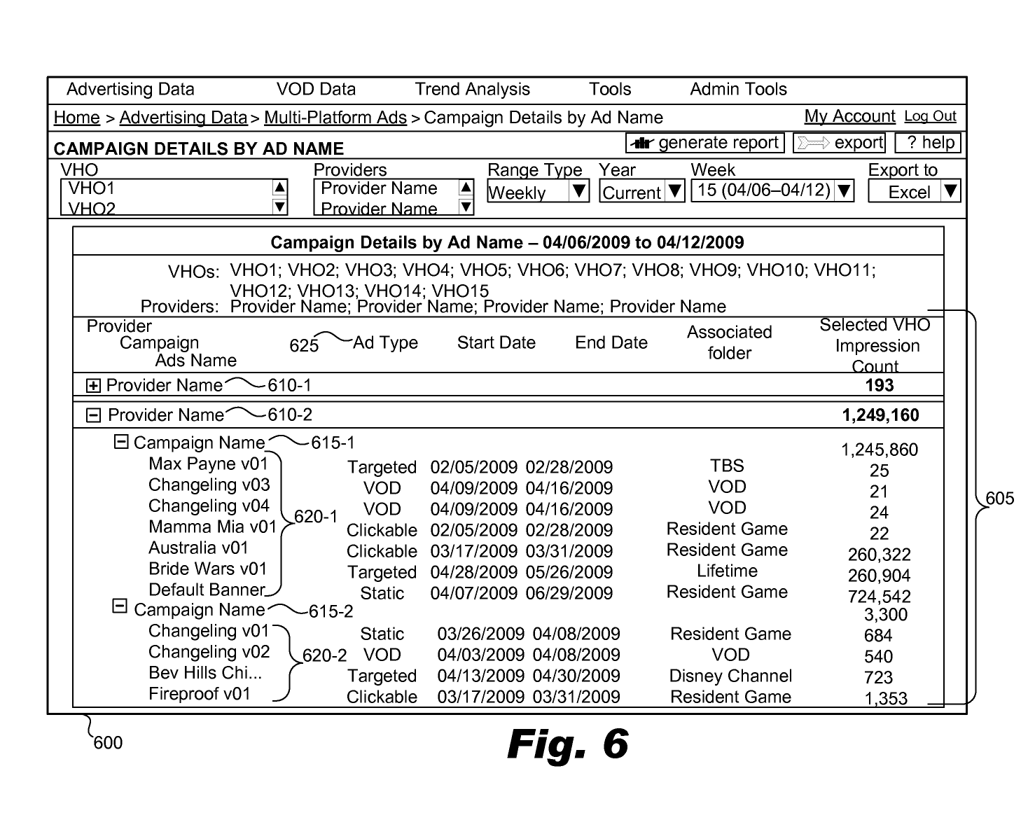

FIG. 6 illustrates an exemplary view 600 that may be displayed within GUI 150. View 600 may include a single report view including multi-platform advertising performance data displayed concurrently therein. Accordingly, a user of access device 140 may concurrently view multi-platform advertising performance data in a single report view.

Multi-platform advertising performance data displayed in view 600 is represented as reference number 605. View 600 may include any advertising performance data, including any examples of advertising performance data disclosed herein. In view 600, the displayed advertising performance data includes impression counts for various advertisements. As mentioned above, an impression count may indicate a number of times that an advertisement has been distributed and/or presented for experiencing by one or more users (e.g., subscribers), or requested or otherwise interacted with by one or more users.

View 600 may include advertising performance data associated with one or more advertising content providers. In the illustrated example, performance data for a first provider 610-1 and a second provider 610-2 is displayed. For the first provider 610-1, the performance data is collapsed and a total impression count for the first provider 610-1 is displayed. For the second provider 610-2, the performance data is expanded to show a total impression count for the second provider 610-2 as well as a breakdown of impression counts by campaign.

As shown in view 600, two advertising campaigns, a first campaign 615-1 and a second campaign 615-2, are associated with the second provider 610-2. A total impression count for each campaign is displayed in view 600. In addition, the performance data for each campaign is expanded to show a breakdown of impression counts by advertisement.

As shown in view 600, names of advertisements associated with each campaign 615-1 and 615-2 are displayed under the corresponding campaign name. In view 600, a first set of advertisements represented as reference number 620-1 are associated with and displayed under the first campaign 615-1 and a second set of advertisements represented as reference number 620-2 are associated with and displayed under the second campaign 615-2. An impression count is displayed for each advertisement associated with campaigns 615-1 and 615-2. The sets of advertisements 620-1 and 620-2 displayed in view 600 may represent or otherwise be associated with certain groupings 490 of aggregate ad performance data 480 shown in FIG. 4.

As represented by reference number 625 in view 600, an ad type for each advertisement may be displayed in view 600. The ad types may include any of the types of advertisements disclosed above. As shown in FIG. 6, advertisements 620-1 associated with the first campaign 615-1 may have ad types labeled as “targeted,” “VOD,” “clickable,” and “static.” Advertisements 620-2 associated with the second campaign 615-2 may also have ad types labeled as “targeted,” “VOD,” “clickable,” and “static.” These labels may correspond to any of the types of advertisements disclosed above. For example, a “targeted” advertisement may be a targeted, linear type advertisement, a “VOD” advertisement may be a VOD type advertisement, and “clickable” and “static” may be different classes of banner type advertisements.

Accordingly, as shown in view 600, reporting data may be displayed in GUI 150 to represent groupings 490 of heterogeneous advertisements (e.g., advertisements of different types), which groupings 490 may have been formed by selectively aggregating performance data of related advertisements across heterogeneous advertising platforms, as described herein.

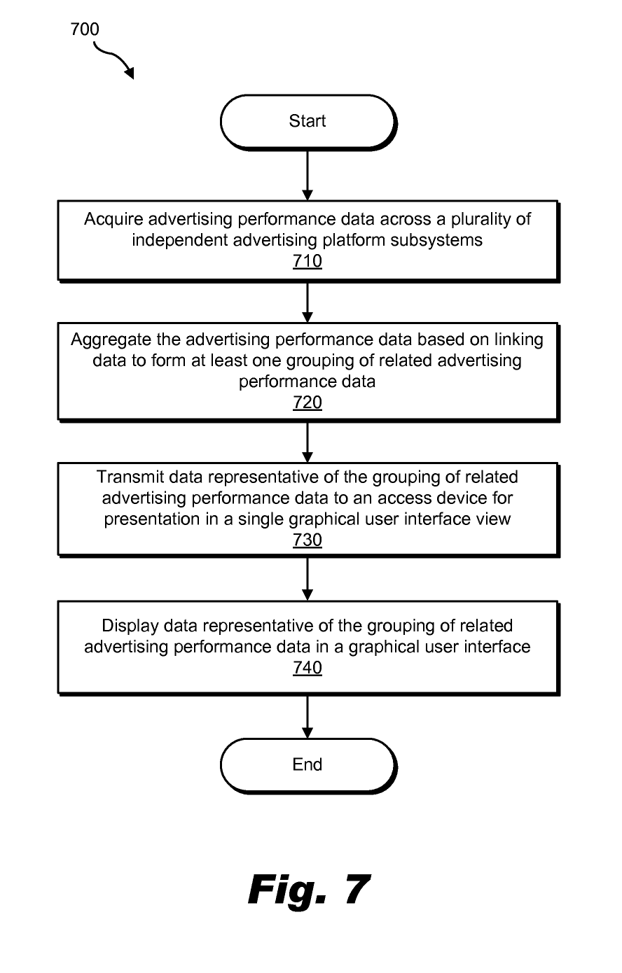

FIG. 7 illustrates an exemplary method 700 of aggregating and reporting advertising performance data of independent advertising platforms. While FIG. 7 illustrates exemplary steps according to one embodiment, other embodiments may omit, add to, reorder, and/or modify any of the steps shown in FIG. 7.

In step 710, advertising performance data is acquired across a plurality of independent advertising platform subsystems 110. Step 710 may be performed in any of the ways described above, including aggregation subsystem 120 acquiring advertising performance data from advertising platform subsystems 110 as described above.

In step 720, the acquired advertising performance data is aggregated based on linking data to form at least one grouping of related advertising performance data. Step 720 may be performed in any of the ways described above, including aggregation subsystem 120 aggregating advertising performance data 460 across multiple advertising platform subsystems 110 based on linking data 470 to form a grouping 490 (e.g., grouping 490-1) of related advertising performance data 480.

In step 730, data representative of the grouping of related advertising performance data is transmitted to an access device 140 for presentation in a single graphical user interface view. Step 730 may be performed in any of the ways described above, including aggregation subsystem 120 transmitting reporting data representative of grouping 490 of related advertising performance data to access device 140 for presentation in a single view in GUI 150.

In step 740, data representative of the grouping of related advertising performance data is displayed in a graphical user interface. For example, the transmitted data representative of the grouping of related advertising performance data may be displayed by access device 140 in a single view (e.g., view 600) within GUI 150 for viewing by a user of the access device 140.

One or more of the steps shown in FIG. 7 may be repeated to form one or more other groupings 490 of aggregate ad performance data. Accordingly, multiple groupings 490 of related ad performance data may be produced and provided to access device 140 for display in GUI 150. In certain embodiments, a single view within GUI 150 may include data representative of multiple different groupings 490 of related ad performance data. In certain embodiments, an advertiser may provide linking data 470 designed to be used to aggregate ad performance data for display in a custom view in GUI 150, and the linking data 470 may be used in method 700 to produce and display the custom view in GUI 150.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A method comprising:
acquiring, by a computing system, advertising performance data from a plurality of independent advertising platform subsystems;
aggregating, by said computing system, said advertising performance data based on linking data to form a grouping of related advertising performance data; and
transmitting, by said computing system, data representative of said grouping of related advertising performance data to an access device for presentation in a single graphical user interface view.

2. The method of claim 1, wherein said grouping of related advertising performance data comprises a subset of said advertising performance data aggregated across said plurality of independent advertising platform subsystems.

3. The method of claim 1, wherein said independent advertising platform subsystems are heterogeneous.

4. The method of claim 1, wherein each of said independent advertising platform subsystems distributes a distinct type of advertisement via a media outlet.

5. The method of claim 1, wherein each of said independent advertising platform subsystems utilizes a distinct tool to generate a portion of said advertising performance data.

6. The method of claim 1, wherein said linking data comprises a campaign identifier and a plurality of advertisement asset identifiers associated with said campaign identifier.

7. The method of claim 6, wherein said aggregating comprises aggregating said advertising performance data based on said campaign identifier and said plurality of advertisement asset identifiers to form said grouping of related advertising performance data.

8. The method of claim 7, wherein said grouping of related advertising performance data comprises a plurality of performance data instances associated with a plurality of advertising assets indicated by said plurality of advertisement asset identifiers.

9. The method of claim 1, further comprising displaying, by said access device, said grouping of related advertising performance data in said single graphical user interface view within a graphical user interface.

10. The method of claim 1, wherein said plurality of independent advertising platform subsystems comprises at least two of a video-on-demand advertising platform subsystem, a linear ad advertising platform subsystem, and a banner ad advertising platform subsystem.

11. The method of claim 10, wherein said at least two of said video-on-demand advertising platform subsystem, said linear ad advertising platform subsystem, and said banner ad advertising platform subsystem distribute heterogeneous types of advertisements via a subscriber television media outlet.

12. The method of claim 1, tangibly embodied as computer-executable instructions on at least one computer-readable medium.

13. A system comprising:
a processing facility;
an aggregation facility communicatively coupled to said processing facility, said aggregation facility configured to direct said processing facility to
acquire advertising performance data from a plurality of independent advertising platform subsystems, and
aggregate said advertising performance data based on linking data to form a grouping of related advertising performance data; and
a reporting facility communicatively coupled to said processing facility, said reporting facility configured to direct said processing facility to transmit data representative of said grouping of related advertising performance data to an access device for presentation in a single graphical user interface view.

14. The system of claim 13, wherein said grouping of related advertising performance data comprises a subset of said advertising performance data aggregated across said plurality of independent advertising platform subsystems.

15. The system of claim 13, wherein said independent advertising platform subsystems are heterogeneous.

16. The system of claim 13, wherein said linking data comprises a campaign identifier and a plurality of advertisement asset identifiers associated with said campaign identifier.

17. The system of claim 16, wherein said aggregation facility is configured to aggregate said advertising performance data based on said campaign identifier and said plurality of advertisement asset identifiers to form said grouping of related advertising performance data.

18. The system of claim 17, wherein said grouping of related advertising performance data comprises a plurality of performance data instances associated with a plurality of advertising assets indicated by said plurality of advertisement asset identifiers.

19. The system of claim 13, wherein said plurality of independent advertising platform subsystems comprises at least two of a video-on-demand advertising platform subsystem, a linear ad advertising platform subsystem, and a banner ad advertising platform subsystem configured to distribute heterogeneous types of advertisements via a subscriber television media outlet.

20. A system comprising:
a plurality of heterogeneous and independent advertising platform subsystems configured to distribute advertisement assets via a subscriber television media outlet;
an aggregation subsystem communicatively coupled to said heterogeneous and independent advertising platform subsystems, said aggregation subsystem configured to
acquire advertising performance data from said plurality of heterogeneous and independent advertising platform subsystems;
aggregate said advertising performance data to form a grouping of a subset of said advertising performance data, said grouping of said subset of said advertising performance data including performance data instances from across said plurality of heterogeneous and independent advertising platform subsystems; and
transmit data representative of said grouping of said subset of said advertising performance data to an access device for presentation in a single graphical user interface view.
